(19) United States
(12) Patent Application Publication
(10) Pub. No.: US 2015/0229802 A1
(43) Pub. Date: Aug. 13, 2015

(54) ELECTRONIC DEVICE, CONTROL METHOD, AND CONTROL PROGRAM

(71) Applicant: KYOCERA CORPORATION, Kyoto-shi, Kyoto (JP)

(72) Inventors: Saya Miura, Yokohama-shi (JP); Hisae Honma, Yokohama-shi (JP)

(21) Appl. No.: 14/430,664

(22) PCT Filed: Sep. 25, 2013
(86) PCT No.: PCT/JP2013/075898

§ 371 Date: Mar. 24, 2015

(30) Foreign Application Priority Data
Sep. 26, 2012 (JP) 2012-212785

(51) Int. Cl. H04N 1/21; H04N 5/232

(52) U.S. Cl. CPC H04N 1/2129; H04N 5/23293

(57) ABSTRACT

According to one of aspects, an electronic device includes: a camera; a storage configured to store therein a plurality of pieces of data of images photographed by the camera; and a controller. The controller is configured to receive specification of a group to be associated with a piece of data of an image to be stored in the storage before the image is photographed by the camera.

### CROSS-REFERENCE TO RELATED APPLICATION

This application is a National Stage of PCT international application Ser. No. PCT/JP2013/075898 filed on Sep. 25, 2013 which designates the United States, incorporated herein by reference, and which is based upon and claims the benefit of priority from Japanese Patent Applications No. 2012-212785 filed on Sep. 26, 2012, the entire contents of which are incorporated herein by reference.

### FIELD

The present application relates to an electronic device, a control method, and a control program.

### BACKGROUND

Some electronic devices such as mobile phones or smartphones include therein a camera (see Patent Literature 1). For example, some mobile phones including a camera allow the user to specify a storage destination folder in which image data photographed by the camera is stored or to specify a size of the image data to be stored (See Patent Literature 2).

### CITATION LIST

### Patent Literature

Patent Literature 1: Japanese Patent Application Laid-open No. 2002-271671

Patent Literature 2: Japanese Patent Application Laid-open No. 2004-320622

### TECHNICAL PROBLEM

In the electronic devices such as mobile phones or smartphones, there are needs for improving management of image data.

### SUMMARY

According to one of aspects, an electronic device includes: a camera; a storage that stores therein data of an image photographed by the camera; and a controller configured to receive specification of a group of an image to be photographed before the image is photographed by the camera.

According to one of aspects, a control method is for controlling an electronic device including a camera and a storage that stores therein data of an image photographed by the camera. The control method includes: receiving specification of a group of an image to be photographed before the image is photographed by the camera; and storing data of the image in the storage in association with the group.

According to one of aspects, a control program causes an electronic device including a camera and a storage that stores therein data of an image photographed by the camera to execute: receiving specification of a group of an image to be photographed before the image is photographed by the camera; and storing data of the image in the storage in association with the group.

### BRIEF DESCRIPTION OF DRAWINGS

FIG. 1 is a block diagram of a smartphone according to one of embodiments.

FIG. 2 is a diagram illustrating one of examples of control in receiving specification of a group of an image to be photographed before the image is photographed by a camera.

FIG. 3 is a diagram illustrating one of examples of control in receiving a comment to be associated with data of an image photographed by a camera.

FIG. 4 is a conceptual diagram of groups associated with image data.

FIG. 5 is a diagram illustrating one of examples of a processing procedure for determining a group to be associated with an image before the image is photographed by a camera.

FIG. 6 is a diagram illustrating one of examples of control for displaying a plurality of image files associated with the same group on a display.

FIG. 7 is a diagram illustrating one of examples of control for editing a file structure of image files associated with the same group.

FIG. 8 is a diagram illustrating one of examples of control for canceling association with a group at once, regarding all image files associated with the same group.

### DESCRIPTION OF EMBODIMENTS

Embodiments of an electronic device, a control method, and a control program according to the present application will be described in detail with reference to the accompanying drawings. In the following, a smartphone will be described as one of examples of the electronic device.

### Embodiment 1

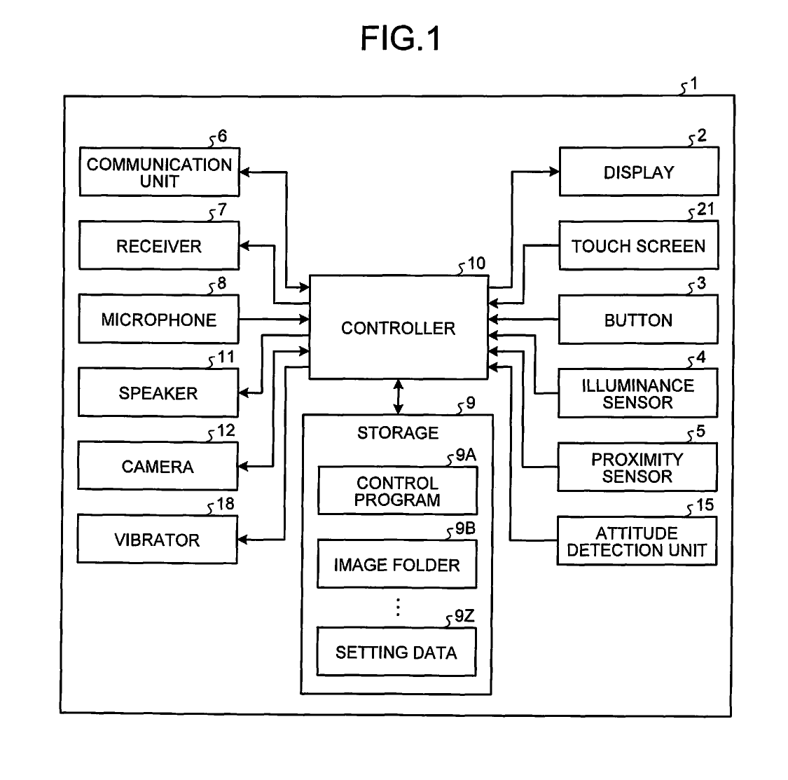

A functional configuration of a smartphone 1 according to Embodiment 1 will be described with reference to FIG. 1. FIG. 1 is a block diagram of a smartphone according to one of embodiments. In the following description, the same numerals may be assigned to the same elements, and an overlapped explanation may not be repeated.

As illustrated in FIG. 1, the smartphone 1 includes a display 2, a button 3, an illuminance sensor 4, a proximity sensor 5, a communication unit 6, a receiver 7, a microphone 8, a storage 9, a controller 10, a speaker 11, a camera 12, an attitude detection unit 15, a vibrator 18, and a touch screen 21.

The display 2 includes a display device such as a liquid crystal display (LCD), an organic electro-luminescence display (OELD), or an inorganic electro-luminescence display (IELD). The display 2 displays characters, images, symbols, and graphics, for example.

The button 3 receives an operation input from a user. A single or a plurality of buttons 3 may be provided.

The illuminance sensor 4 detects illuminance of ambient light of the smartphone 1. The illuminance indicates the intensity, the brightness, or the luminance of light. The illuminance sensor 4 is used to adjust the luminance of the display 2, for example.

The proximity sensor 5 detects existence of a neighboring object in a non-contact manner. The proximity sensor 5 detects the existence of an object based on the change in a magnetic field or the change in returning time of reflected waves of ultrasonic waves, for example. The proximity sensor 5 detects the approach of the display 2 to a face. The illuminance sensor 4 and the proximity sensor 5 may be configured as a single sensor. The illuminance sensor 4 may be used as a proximity sensor.

The communication unit 6 performs communication wirelessly. The wireless communication standards supported by the communication unit 6 include communication standards of cellular phones such as 2G, 3G, and 4G, and short range wireless communication standards. The communication standards of cellular phones include the long term evolution (LTE), the wideband code division multiple access (W-CDMA), the worldwide interoperability for microwave access (WiMax), the CDMA2000, the personal digital cellular (PDC), the global system for mobile communications (GSM)(registered trademark), and the personal handy-phone system (PHS), for example. The short range wireless communication standards include the IEEE802.11, the Bluetooth (registered trademark), the infrared data association (IrDA), the near field communication (NFC), and the wireless personal area network (WPAN), for example. The communication standard of the WPAN includes the ZigBee (registered trademark), for example. The communication unit 6 may support one or more of the above-described communication standards.

The communication unit 6 receives radio wave signals of a given frequency band from GPS satellites, performs decoding processing of the received radio wave signals, and transmits the processed signals to the controller 10. In the smartphone 1, the function for performing communication with GPS satellites may be separated from the communication unit 6, and a separate communication unit independent from the communication unit 6 may be provided.

The receiver 7 is a sound output unit. The receiver 7 outputs sound signals transmitted from the controller 10 as sound. The receiver 7 is used to output voice of an opposite party during a call, for example. The microphone 8 is a sound input unit. The microphone 8 converts voice of a user and the like into sound signals and transmits them to the controller 10.

The storage 9 stores therein computer programs and data. The storage 9 is also used as a work area for temporarily storing processing results of the controller 10. The storage 9 may include an arbitrary non-transitory storage medium such as a semiconductor storage medium and a magnetic storage medium. The storage 9 may include a plurality of kinds of storage media. The storage 9 may include the combination of a portable storage medium such as a memory card, an optical disk, or a magneto-optical disk, and a storage medium reading device. The storage 9 may include a storage device used as a temporary storage area such as a random access memory (RAM).

The computer programs stored in the storage 9 includes applications executed in the foreground or the background, and control programs for supporting operation of the applications. The application executed in the foreground causes the display 2 to display a screen, for example. The control programs include an OS, for example. The applications and the control programs may be installed in the storage 9 through wireless communication by the communication unit 6 or a non-transitory storage medium.

The storage 9 stores therein a control program 9A, an image folder 9B, and setting data 9Z, for example.

The control program 9A provides functions related to various kinds of control to operate the smartphone 1. The control program 9A provides a function for displaying, on the display 2, a group setting window for receiving specification of a group of an image to be photographed before the image is photographed by the camera 12, for example. The control program 9A provides a function for displaying, on the display 2, a comment input window for receiving an input of a comment to be associated with data of an image photographed by the camera 12. The control program 9A provides a function for storing data of an image photographed by the camera 12 in the image folder 9B in association with a group received from a user through the group setting window. The comment data may be inserted in image data in some cases.

In addition, the control program 9A provides, for example, a function for controlling the communication unit 6 to achieve communication using the long term evolution (LTE), the wideband code division multiple access (W-CDMA), the worldwide interoperability for microwave access (WiMax), the CDMA2000, the personal digital cellular (PDC), the global system for mobile communications (GSM) (registered trademark), the personal handy-phone system (PHS), etc.

The control program 9A provides, for example, a function for controlling the communication unit 6 to achieve short range wireless communication using the IEEE802.11, the Bluetooth (registered trademark), the infrared data association (IrDA), the near field communication (NFC), the wireless personal area network (WPAN), etc.

The control program 9A provides, for example, a function for controlling the communication unit 6, the microphone 8, and the like to achieve a phone call.

The functions provided by the control program 9A may be divided to a plurality of program modules or combined with another program.

The image folder 9B stores therein image data associated with the group described above. The image data includes not only still images but also moving images. The groups may be managed by unique identification information such as a number or a symbol as in “001: child”, “002: food”, and “003: travel”, for example. The comment data may be inserted in image data in some cases. The comment data is associated with image data as text data.

The setting data 9Z includes information of various kinds of settings and processing related to the action of the smartphone 1. The setting data 9Z includes information of groups with which images photographed by the camera 12 are associated, for example. The setting data 9Z includes information of whether the setting for receiving specification of a group of an image to be photographed before the image is photographed by the camera 12 is in a valid state.

The controller 10 is a processor. The processor includes a central processing unit (CPU), a system-on-a-chip (SoC), a micro control unit (MCU), and a field-programmable gate array (FPGA), for example, but is not limited thereto. The controller 10 integrally controls the operation of the smartphone 1 to achieve various functions.

To be more specific, the controller 10 executes instructions included in the computer programs stored in the storage 9 while referring to data stored in the storage 9, as necessary. The controller 10 then controls functional units in accordance with data and instructions, thereby achieving various functions. The functional units include the display 2, the communication unit 6, the receiver 7, the microphone 8, and the speaker 11, for example, but are not limited thereto. The controller 10 may change control depending on detection results of detection units. The detection units include the button 3, the illuminance sensor 4, the proximity sensor 5, the microphone 8, the camera 12, and the attitude detection unit 15, and the touch screen 21, for example, but are not limited thereto.

The controller 10 executes the control program 9A, thereby achieving processing of displaying, on the display 2, the group setting window for receiving specification of a group of an image to be photographed before the image is photographed by the camera 12. The controller 10 executes the control program 9A, thereby achieving processing of displaying, on the display 2, the comment input window for receiving an input of a comment to be associated with data of an image photographed by the camera 12. The controller 10 executes the control program 9A, thereby achieving processing of storing data of an image photographed by the camera 12 in the image folder 9B in association with a group received from a user through the group setting window.

The speaker 11 is a sound output unit. The speaker 11 outputs sound signals transmitted from the controller 10 as sound. The speaker 11 is used to output a ringtone and music, for example. One of the receiver 7 and the speaker 11 may have the function of the other.

The camera 12 converts a photographed image into electric signals. The camera 12 includes an in-camera for photographing an object facing the display 2 and an out-camera for photographing an object facing the opposite face of the display 2, for example.

The attitude detection unit 15 detects the attitude of the smartphone 1. In order to detect the attitude, the attitude detection unit 15 includes at least one of an acceleration sensor, a direction sensor, and a gyroscope.

The vibrator 18 vibrates a part or the entire of the smartphone 1. In order to generate vibration, the vibrator 18 includes a piezoelectric element or an eccentric motor, for example. The vibration by the vibrator 18 is used to notify a user of various events such as an incoming call.

The touch screen 21 detects contact with the touch screen 21. The controller 10 (the smartphone 1) detects various kinds of operation (gestures) performed on the touch screen 21 using a finger, a stylus, a pen, or the like (hereinafter, simply referred to as a “finger”), based on contact detected by the touch screen 21. For example, the touch screen 21 includes a touch sensor. The touch sensor detects contact of a finger with the touch screen 21 together with a position of the contacted area on the touch screen 21, and notifies the controller 10 of them. Various kinds of operation (gestures) detected by the controller 10 through the touch screen 21 includes a touch, a long-touch, releasing, a swipe, a tap, a double-tap, a long-tap, dragging, a flick, a pinch-in, and a pinch-out, for example, but are not limited thereto. The detection system of the touch screen 21 may be an arbitrary system such as a capacitive system, a resistive film system, a surface acoustic wave system (or an ultrasonic system), an infrared system, an electromagnetic induction system, and a load detection system. As illustrated in FIG. 1, the display 2 and the touch screen 21 are separated functionally, but may be integrated physically as a touch screen display.

The functional configuration of the smartphone 1 is exemplarily illustrated in FIG. 1, and may be appropriately modified in a range not impairing the scope of the invention.

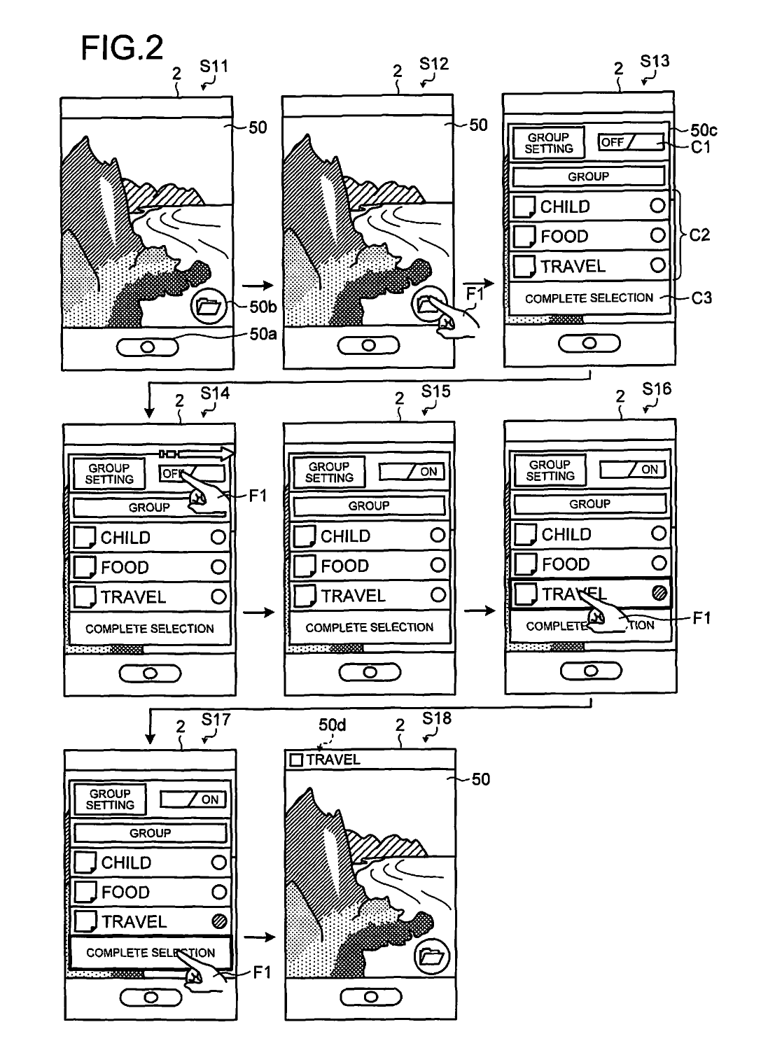

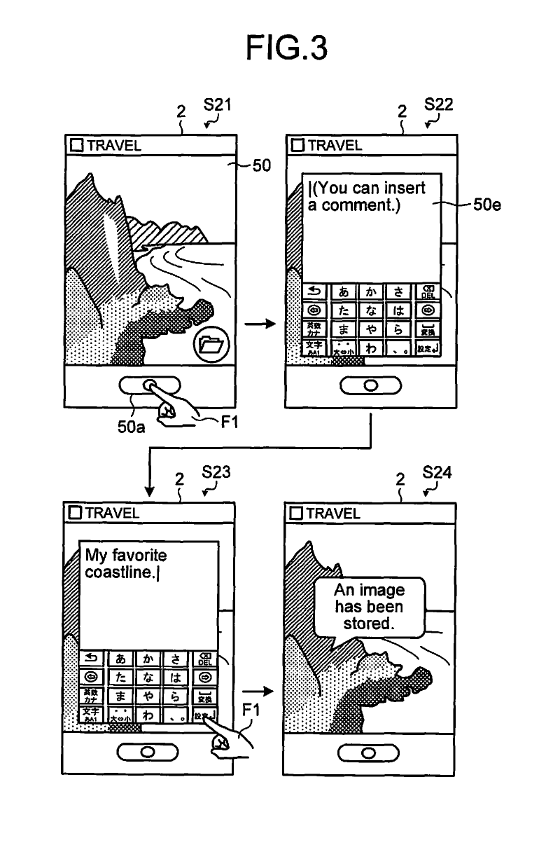

Examples of control in photographing an image by the smartphone 1 will be described with reference to FIG. 2 and FIG. 3. A “F1” illustrated in FIG. 2 and FIG. 3 indicates a finger of a user. In the following description, the “operation” described without any specific definition may be any operation to be detected such as a touch, a tap, a swipe, and a double-tap, as long as the correspondence thereof to the following processing does not conflict with the correspondence thereof to another processing.

FIG. 2 is a diagram illustrating one of examples of control in receiving specification of a group of an image to be photographed before the image is photographed by the camera 12.

As illustrated in FIG. 2, the smartphone 1 activates the camera 12 and displays a screen 50 of image data to be captured by the camera 12 on the display 2 (Step S11). Here, the smartphone 1 displays, on the screen 50, an icon 50b for performing setting for associating data of an image to be photographed with a group. An imaging button 50a for photographing the image data as an image is provided on the screen 50.

Subsequently, when detecting a user's operation on the icon 50b through the touch screen 21 (Step S12), the smartphone 1 displays a group setting window 50c on the screen 50 on the display 2 (Step S13). The group setting window 50c is provided with an operating part C1 for switching a group setting between ON and OFF, an operating part C2 for selecting a group with which data of an image to be photographed is associated, and an operating part C3 for performing operation of completing selection. At Step S13, the display of the operating part C1 is OFF. Thus, the group setting is in an invalid state.

Subsequently, when detecting a swipe on the operating part C1 of the group setting window 50c through the touch screen 21 (Step S14), the smartphone 1 switches the group setting into a valid state and switches the display of the operating part C1 from OFF to ON (Step S15). The operation on the operating part C1 detected by the smartphone 1 at Step S14 may be any operation other than a swipe.

Subsequently, when detecting a tap on the operating part C2 of the group setting window 50c through the touch screen 21, the smartphone 1 puts a portion of the group corresponding to a position at which the tap is detected into a selected state (Step S16). For example, the smartphone 1 displays an image in which a part (a round mark) of the portion where “travel” is described that corresponds to the position at which the tap is detected is lit, thereby notifying a user of the selected state of the “travel” as a group. The groups in FIG. 2 are illustrated only exemplarily. The groups may be registered in advance or may be configured to be added at arbitrary timing.

Subsequently, when detecting a tap on the operating part C3 of the group setting window 50c through the touch screen 21 (Step S17), the smartphone 1 completes the group setting and displays the screen 50 again on the display 2 (Step S18). Here, the smartphone 1 displays “travel” on the screen 50 as a current selected group (see 50d). The smartphone 1 stores data of the image photographed by the camera 12 after Step S18 in the image folder 9B, in association with the selected group.

FIG. 3 is a diagram illustrating one of examples of control in receiving a comment to be associated with data of an image photographed by the camera 12.

As illustrated in FIG. 3, when detecting operation on the imaging button 50a of the screen 50 through the touch screen 21 (Step S21), the smartphone 1 acquires data of an image photographed by the camera 12 and displays, on the display 2, a comment input window 50e for receiving a comment to be associated with the data of the image from a user (Step S22). The comment input window 50e includes an area for displaying input characters and an area of a software keyboard, for example.

Subsequently, when the characters input in the comment input window 50e are fixed (Step S23), the smartphone 1 stores the acquired image data and the input comment in the image folder 9B in association with the selected group (travel, for example), and displays a message for the user (Step S24).

When images are stored, the smartphone 1 may collectively manage all images photographed from activation of the operation of the camera 12 to end of operation of the camera 12, as an album in the image folder 9B. In this case, the smartphone 1 associates a group for the album.

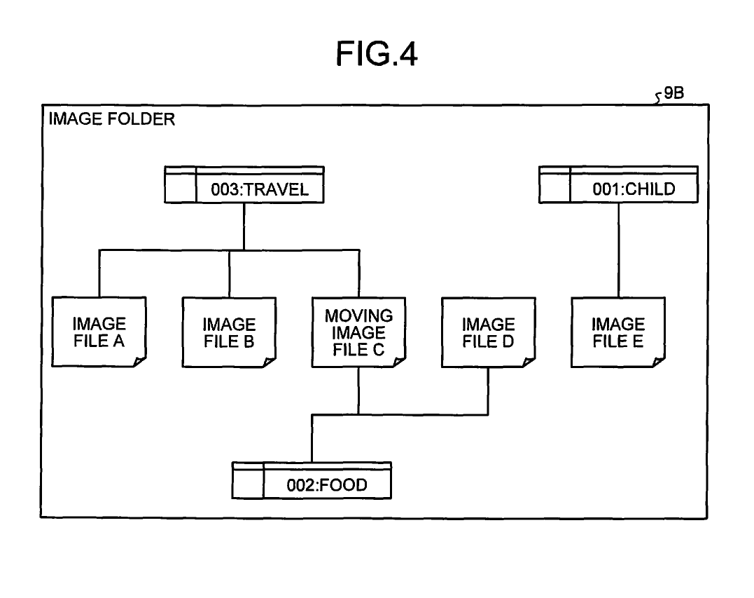

FIG. 4 is a conceptual diagram of groups associated with image data. As illustrated in FIG. 4, the image folder 9B stores therein an image file A, an image file B, a moving image file C, an image file D, and an image file E, for example. The image file A and the image file B are associated with “travel” with a group number 003. The moving image file C is associated with “travel” with the group number 003 and “food” with a group number 002. The image file D is associated with “food” with the group number 002. The image file E is associated with “child” with a group number 001. In this manner, in Embodiment 1, the smartphone 1 stores data of an image photographed by the camera 12 in the image folder 9B, in association with a group specified by a user before the image is photographed by the camera 12. Therefore, according to Embodiment 1, image data can be searched and browsed easily by specifying a group even if a plurality of pieces of image data are stored in the same folder.

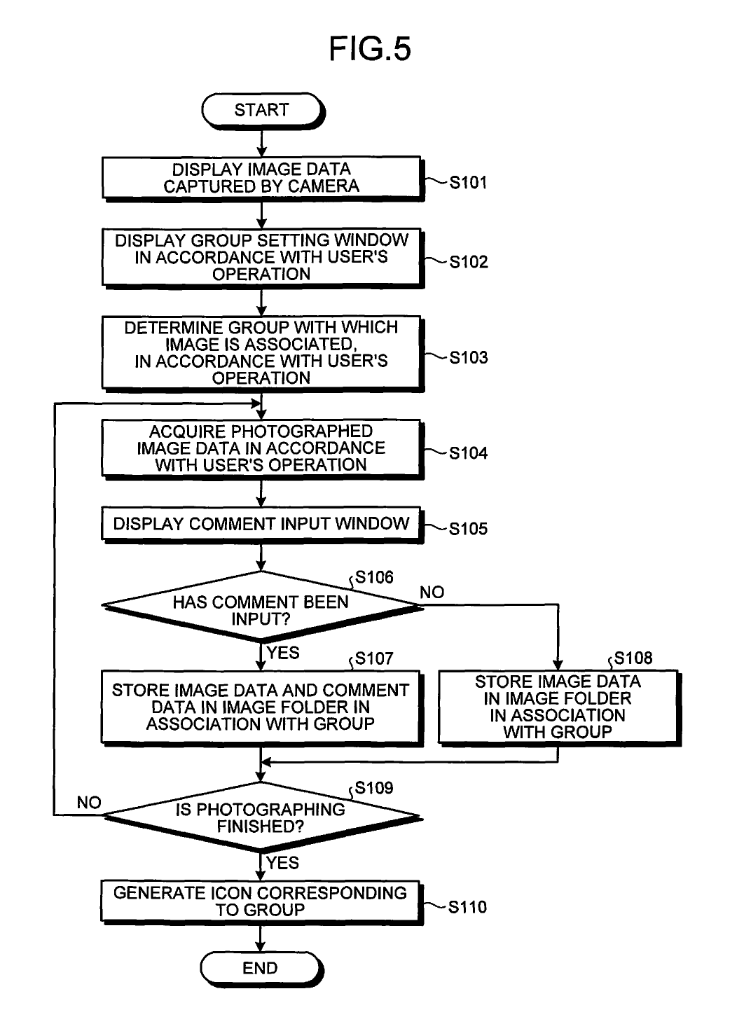

One of examples of the processing procedure of the smartphone 1 according to Embodiment 1 will be described with reference to FIG. 5. FIG. 5 is a diagram illustrating one of examples of a processing procedure for determining a group to be associated with an image before the image is photographed by the camera 12. The processing procedure illustrated in FIG. 5 is started with activation of the camera 12, for example. The processing procedure illustrated in FIG. 5 is achieved by execution of the control program 9A stored in the storage 9 by the controller 10, for example.

As illustrated in FIG. 5, when the camera 12 is activated, the controller 10 displays the screen 50 of image data captured by the camera 12 on the display 2 (Step S101). Here, the smartphone 1 displays, on the screen 50, the icon 50b for performing setting for associating data of an image to be photographed with a group and the imaging button 50a for photographing image data as an image.

Subsequently, when detecting user's operation on the icon 50b through the touch screen 21, the controller 10 displays the group setting window 50c on the display 2 in accordance with the detected user's operation (Step S102). The group setting window 50c is provided with the operating part C1 for switching a group setting between ON and OFF, the operating part C2 for selecting a group with which data of an image to be photographed is associated, and the operating part C3 for performing operation of completing selection (see FIG. 2).

Subsequently, the controller 10 determines a group with which an image to be photographed by the camera 12 is associated, in accordance with user's operation detected on the group setting window 50c (Step S103). The Step S103 will be described concretely. When detecting operation on the operating part C1 of the group setting window 50c, for example, the controller 10 switches the group setting into a valid state. When detecting operation on the operating part C2 of the group setting window 50c through the touch screen 21 after switching the group setting into a valid state, the smartphone 1 puts the group corresponding to a position at which the tap is detected into a selected state. Then, when detecting a tap on the operating part C3 of the group setting window 50c through the touch screen 21, the controller 10 completes the group setting. After completing the group setting, the controller 10 displays the screen 50 again on the display 2.

Subsequently, the controller 10 acquires the image data photographed by the camera 12 in accordance with user's operation on the imaging button 50a of the screen 50 (Step S104).

Subsequently, the controller 10 displays the comment input window 50e on the display 2 (Step S105). The comment input window 50e includes an area for displaying input characters and an area of a software keyboard, for example (see FIG. 3).

Subsequently, the controller 10 determines whether a comment has been input on the comment input window 50e (Step S106).

When the comment has been input as a result of the determination (Yes at Step S106), the controller 10 stores the image data and the comment data in the image folder 9B, in association with the group determined at Step S103 (Step S107). For example, the controller 10 stores the image data in a format of file.

On the other way, when a comment has not been input as a result of the determination (No at Step S106), the controller 10 stores the image data in the image folder 9B, in association with the group determined at Step S103 (Step S108).

Subsequently, the controller 10 determines whether the photographing by the camera 12 is finished (Step S109). For example, the controller 10 determines that the photographing is finished when the operation of the camera 12 is finished. Alternatively, the controller 10 may display a screen for prompting a user to select whether or not to finish the photographing every time the photographing is performed, and determine that the photographing is finished when the user selects to finish the photographing.

When the photographing is finished as a result of the determination (Yes at Step S109), the controller 10 generates an icon corresponding to the group determined at Step S103 (Step S110), and finishes the processing procedure in FIG. 5. On the other way, when the photographing is not finished as a result of the determination (No at Step S109), the controller 10 returns to the processing procedure at Step S104 described above and continues the photographing of an image.

By the time until the photographing is finished, a plurality of pieces of image data (image files) stored in the image folder 9B are associated with the same group by the processing procedure of Step S104 to Step S108 illustrated in FIG. 5. By specifying the group, the user can search image files associated with the same group form among a plurality of image files stored in the image folder 9B.

### Embodiment 2

A plurality of image files, which are stored in the image folder 9B in the state associated with the same group in Embodiment 1, may be displayed on the display 2 or edited.

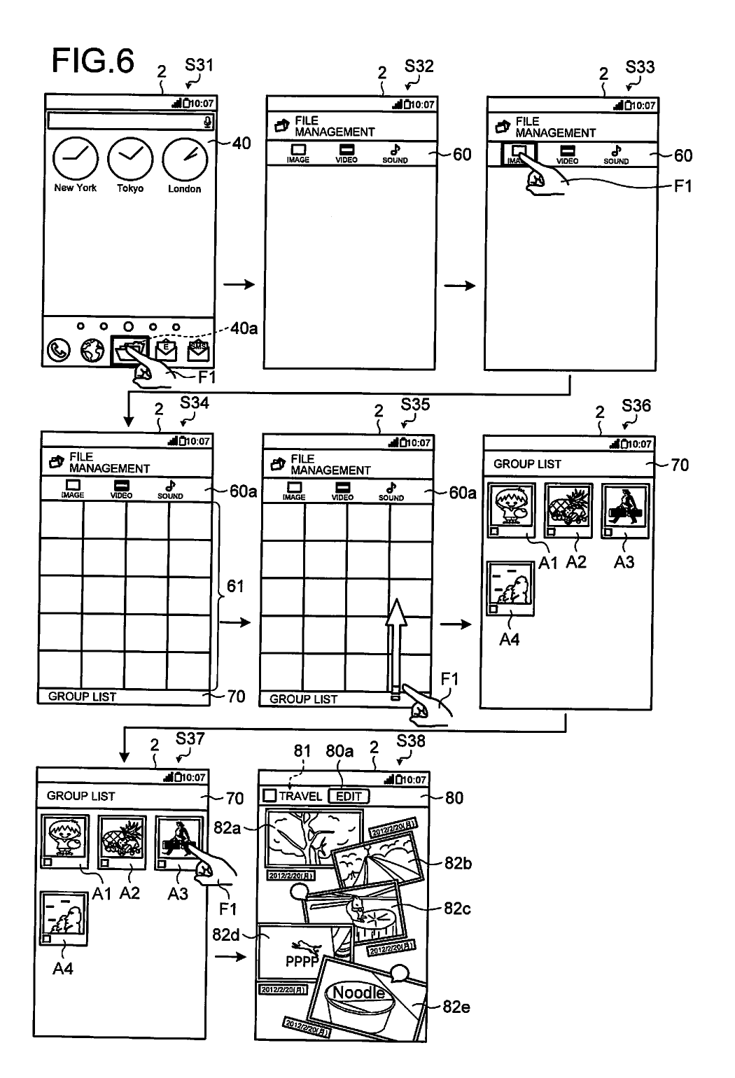

Examples of control by the smartphone 1 in Embodiment 2 will be described with reference to FIG. 6 to FIG. 8. FIG. 6 is a diagram illustrating one of examples of control for displaying a plurality of image files associated with the same group on the display 2.

As illustrated in FIG. 6, in the smartphone 1, an icon 40a for displaying, on the display 2, a file management screen 60 for managing various files stored in the storage 9 is displayed on a home screen 40.

Subsequently, when detecting operation on the icon 40a through the touch screen 21 (Step S31), the smartphone 1 displays the file management screen 60 on the display 2 (Step S32). The file management screen 60 is provided with an operating part for displaying lists of image files, moving image files, and sound files, for example, on the display 2.

Subsequently, when detecting operation on the operating part for displaying a list of image files on the display 2 through the touch screen 21 (Step S33), the smartphone 1 displays a list screen 60a of image files on the display 2 (Step S34). The operation on the operating part for displaying a list of image files on the display 2 may be any operation such as a tap, a double-tap, a touch, and a long-touch, for example. The list screen 60a of image files displays a list 61 of thumbnails corresponding respectively to image files stored in the image folder 9B of the storage 9. Icons or the like may be displayed instead of the thumbnails. Furthermore, the list screen 60a displays a part of a group list screen 70 on which a list of groups associated with image files is displayed.

When detecting operation on a part of the group list screen 70 after displaying the list screen 60a (Step S35), the smartphone 1 displays the group list screen 70 on the display 2 (Step S36). The operation on a part of the group list screen 70 may be any operation such as an upward swipe on the screen, or a tap, a double-tap, a touch, and a long-touch on the screen, for example. On the group list screen 70, icons A1 to A4 corresponding to four groups of group A1 to group A4 are displayed as groups associated with image files, for example. The four groups of the group A1 to the group A4 correspond to “child”, “food”, “travel”, and the like, illustrated in FIG. 2.

Subsequently, when detecting operation on an icon corresponding to the group A3 displayed on the group list screen 70 through the touch screen 21 (Step S37), the smartphone 1 displays, on the display 2, a screen 80 on which image files associated with the group A3 are displayed (Step S38).

On the screen 80, a name of the group corresponding to the group A3 (travel, for example) is displayed (see FIG. 6). On the screen 80, thumbnails corresponding respectively to five image files 82a to 82e associated with the group A3 are displayed. When detecting operation on one of thumbnails, the smartphone 1 displays the corresponding image file on the display 2. Here, when a comment is associated with the image file, the smartphone 1 also displays the comment. A manner of displaying thumbnails is not limited to the example illustrated at Step S38. Icons or the like may be displayed instead of the thumbnails. The screen 80 is provided with an editing button 80a for editing a file structure of image files associated with the group A3.

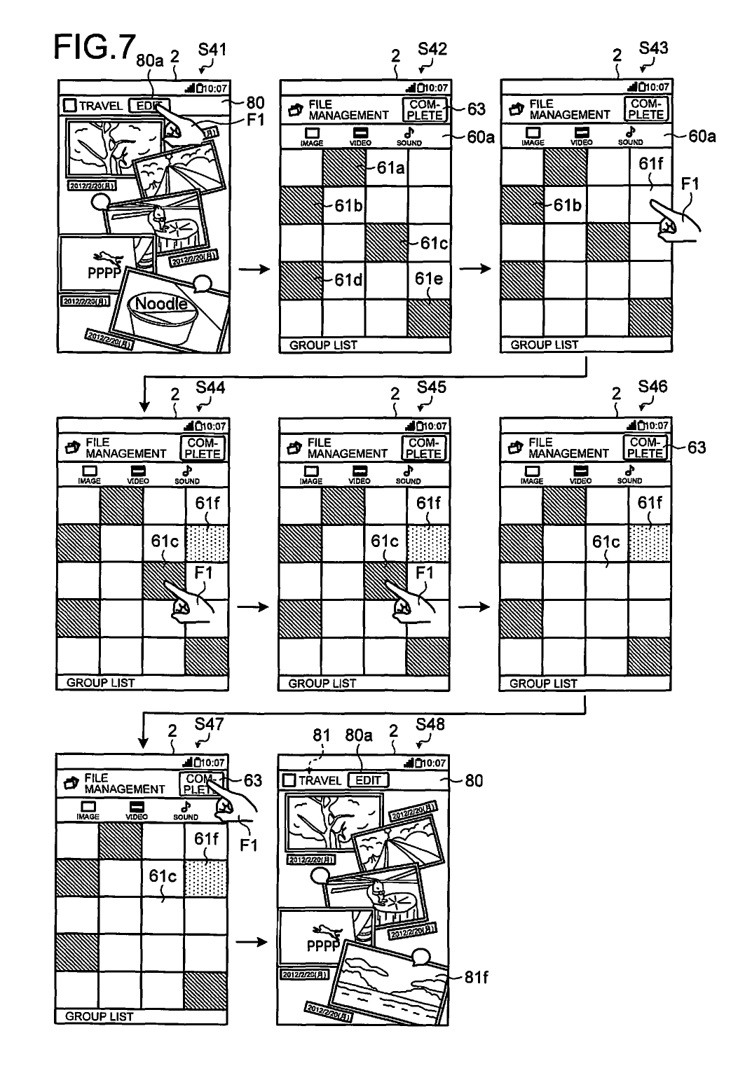

FIG. 7 is a diagram illustrating one of examples of control for editing a file structure of image files associated with the same group. FIG. 7 illustrates one of examples of control for editing a file structure of image files associated with the same group A3 after displaying the screen 80 illustrated in FIG. 6, for example.

As illustrated in FIG. 7, when detecting operation on the editing button 80a of the screen 80 through the touch screen 21 (Step S41), the smartphone 1 displays the list screen 60a of image files on the display 2 (Step S42). The smartphone 1 highlights thumbnails 61a to 61e of the image files associated with the group A3 among image files displayed on the list screen 60a. At Step S42, the smartphone 1 further displays a completion button 63 for receiving completion of editing operation on the list screen 60a.

Subsequently, when detecting operation on a thumbnail 61f displayed on the list screen 60a through the touch screen 21 (Step S43), the smartphone 1 highlights the thumbnail 61f so that the selected state of the thumbnail 61f can be recognized (Step S44). Here, the smartphone 1 may change a manner of highlighting so that the thumbnails 61a to 61e of the image files already associated with the group A3 are not confused with the newly selected thumbnail 61f.

Subsequently, when detecting operation on the thumbnail 61c displayed on the list screen 60a through the touch screen 21 (Step S45), the smartphone 1 cancels highlighting of the thumbnail 61c so that cancellation of the selected state of the thumbnail 61c can be recognized (Step S46).

Subsequently, when detecting operation on the completion button 63 of the list screen 60a through the touch screen 21 (Step S47), the smartphone 1 displays, on the display 2, the screen 80 including a thumbnail 81f corresponding to the newly selected thumbnail 61f instead of the thumbnail 61c (Step S48). By the control illustrated in FIG. 7, the smartphone 1 cancels association of the image file corresponding to the thumbnail 61c with the group A3, and achieves new association of the image file corresponding to the thumbnail 61f with the group A3.

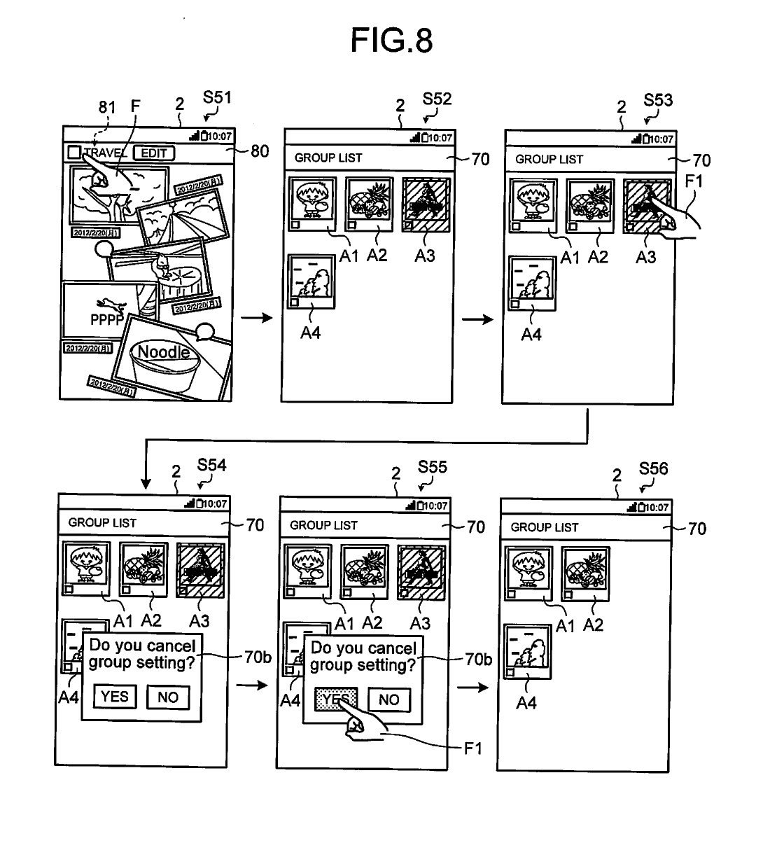

FIG. 8 is a diagram illustrating one of examples of control for canceling association with a group at once, regarding all image files associated with the same group. FIG. 8 illustrates one of examples of control for canceling association with the group A3 at once, regarding all image files associated with the group A3, after displaying the screen 80 illustrated in FIG. 6, for example.

As illustrated in FIG. 8, when detecting operation on a portion at which the group name of the group A3 is displayed through the touch screen 21 (Step S51), the smartphone 1 displays the group list screen 70 (Step S52). At Step S52, the smartphone 1 highlights an icon A3 corresponding to the group A3 when displaying the group list screen 70.

Subsequently, when detecting operation on the icon A3 through the touch screen 21 (Step S53), the smartphone 1 displays a window 70b for inquiring whether or not the group setting is to be canceled on the display 2 (Step S54).

Subsequently, when detecting operation on a portion at which “Yes” is described in the window 70b through the touch screen 21 (Step S55), the smartphone 1 deletes the icon A3 corresponding to the group A3 from the group list screen 70 (Step S56). Thereafter, when detecting operation on the group list screen 70, for example, the smartphone 1 may display the list screen 60a of image files, for example, on the display. The operation on the group list screen 70 may be any operation such as a downward swipe on the screen, or a tap, a double-tap, a touch, and a long-touch on the screen, for example.

By the control illustrated in FIG. 8, the smartphone 1 can delete, at once, the existence of the group A3 itself from among the groups associated with image files stored in the image folder 9B. Thereafter, the user cannot search image files by specifying “travel” as a group from among a plurality of image files stored in the image folder 9B.

Although the art of appended claims has been described with respect to specific embodiments for a complete and clear disclosure, the appended claims are not to be thus limited but are to be construed as embodying all modifications and alternative constructions that may occur to one skilled in the art which fairly fall within the basic teaching herein set forth.

For example, each program illustrated in FIG. 1 may be divided to a plurality of modules. Alternatively, each program illustrated in FIG. 1 may be combined with another program.

In the above-described embodiments, the smartphone has been described as one of examples of the electronic device. However, the device according to the appended claims is not limited to a smartphone. The device according to the enclosed claims may be a mobile electronic device other than a smartphone. The mobile electronic device includes a mobile phone, a tablet, a portable personal computer, a digital camera, a media player, an electronic book reader, a navigator, and a game machine. The device according to the appended claims may be a stationary electronic device. The stationary electronic device includes a desktop personal computer and a television receiver, for example.

1. An electronic device, comprising:
a camera;
a storage configured to store therein a plurality of pieces of data of images photographed by the camera; and
a controller configured to receive specification of a group to be associated with a piece of data of an image to be stored in the storage before the image is photographed by the camera.

2. The electronic device according to claim 1, further comprising:
a display that displays a screen including a list of the plurality of pieces of data of images, wherein
the controller is configured to receive operation of setting or canceling of association between the group and a member of the plurality of pieces of data of images from a user on the screen.

3. A control method for controlling an electronic device including a camera and a storage, the control method comprising:
photographing an image by the camera;
receiving specification of a group of the image before the photographing; and
storing data of the image in the storage in association with the group.

4. A non-transitory storage medium that stores a control program that causes, when executed by an electronic device including a camera and a storage, the electronic device to execute:
photographing an image by the camera;
receiving specification of a group of the image before the photographing; and
storing data of the image in the storage in association with the group.
